(19) United States
(12) Patent Application Publication
(10) Pub. No.: US 2024/0336781 A1
(43) Pub. Date: Oct. 10, 2024

(54) Optical Articles With Embedded Wafer And Wafer Coating Compositions

(71) Applicant: HOYA Optical Labs of America, Inc., Lewisville, TX (US)

(72) Inventors: Hannah Vu, New Brighton, MN (US); Jeffrey Brown, St. Louis Park, MN (US); David Olund, Stanchfield, MN (US); Vikas Parakh, Minneapolis, MN (US)

(73) Assignee: HOYA Optical Labs of America, Inc., Lewisville, TX (US)

(21) Appl. No.: 18/628,487

(22) Filed: Apr. 5, 2024

Related U.S. Application Data
(60) Provisional application No. 63/494,707, filed on Apr. 6, 2023.

(51) Int. Cl. C09D 4/06; C09D 135/02; C09D 169/00; C09D 175/04; C09D 183/08

(52) U.S. Cl. CPC C09D 4/06; C09D 135/02; C09D 169/00; C09D 175/04; C09D 183/08

(57) ABSTRACT

An ophthalmic lens including an embedded functional wafer which is coated on one or both sides with a coating layer and methods for fabricating the same. The coating layer may provide adhesion between the functional wafer and the surrounding resin used to form the lens. The coating layer may also protect the functional wafer from degradation during fabrication, such as due to chemical attack or exposure to heat during thermoforming. The coating layer may be applied to a flat functional sheet and then subsequently formed into a curvature to match the lens, or the coating layer may be applied to an already-curved functional wafer. The coating layer may comprise various compositions known to provide adhesion, protection from heat, and/or protection from chemicals.

### RELATED APPLICATIONS

This application claims benefit of and priority to U.S. Provisional Application Ser. No. 63/494,707 filed Apr. 6, 2023 entitled Optical Articles with Embedded Wafer and Wafer Coating Compositions, which is hereby incorporated herein by reference in its entirety.

### BACKGROUND OF THE INVENTION

Optical articles such as ophthalmic lenses are often desired with additional functions, such as but not limited to photochromic, electrochromic, mirrored, and/or polarized functionality. One known method of adding functionality to such an optical article is to apply a functional coating on the front of the lens article surface, commonly by spin coating process. Another known method of adding functionality to such an optical article is to embed a wafer providing a desired function underneath the front surface of the lens, or by sandwiching the functional wafer between the front and back surfaces of the lens.

Optical articles such as ophthalmic lenses may also include various surface features. Examples of such surface features include bifocal, trifocal or multifocal segmented lenses. Segmented lenses may also be referred to as D28, D35, or by design names. Such lenses with surface features may present challenges, however, in that spin coating process articles with surface features may have an impact on the flow of coating solutions, which can yield non-uniformity of coating thickness and thus nonuniform color once activated.

As an example, such optical articles may be fabricated by inserting a functional film layer or wafer in a gasket and mold set up, filling the mold cavity with a liquid monomer such that the monomer is on both sides of the functional wafer, and polymerizing the monomer into an optical resin while forming a bonding between the wafer and the formed optical resin. FIG. 1 illustrates an example of an ophthalmic lens in which a functional wafer 2 is sandwiched between a first layer 1 and a second layer 3 of a lens material.

U.S. Patent Publication No. 2007/0122626, which is hereby incorporated by reference in its entirety, describes a method to produce a photochromic cast lens with improved photochromic properties, such as by using a photochromic film having at least one protective layer. The protective layer should have good “compatibility” with the lens casting material so as to provide sufficient adhesion without being damaged by chemicals and the like during the fabrication process. Thus, the protective layer should ideally have both optical quality and bonding capability with lens casting materials.

Obtaining a protective layer with such qualities can be challenging. A protective layer which has sufficient protective properties and is not susceptible to, e.g., chemical attack by lens casting material, may be more inert and thus not provide sufficient adhesion to the polymerized casting resin. On the other hand, a protective layer compatible enough for a good bonding with the casting resin may be susceptible to chemical attack by the aggressive casting resin monomer; resulting in a hazy and/or optically opaque result.

Proper adhesion between the protective layer and the casting resin is important in lens production since the semi-finished lens may go through many surfacing and processing steps in Rx surfacing lab and may be exposed to different mechanical, chemical and thermal factors. Without proper adhesion, the protective layer and the casting resin may separate under such harsh processing steps and conditions. Also, proper adhesion is important for sufficient long-term durability of the ophthalmic lens.

Many photochromic lenses may rely on spin coating technology in which a photochromic coating is applied on the front surface of the lens. The photochromic coating layer may often require a coating thickness greater than 10 μm for proper photochromic performance. When optical articles include surface features such as segmented lenses, it can be challenging to achieve a uniform layer of coating thickness and thus uniform color. Photochromic lenses with such surface features can also be produced by blending photochromic dyes in the lens resin in a process referred to as In-Mass Photochromic. Lenses produced with such a process without the control of host environment for photochromic dye activation may activate to lighter color when exposed to an activation light source and fade with slower speed.

Hence, there is a need for an interlayer coating between the cast resin and the protective layer of the functional wafer which will provide protection to the functional wafer and/or function as a good adhesion layer between the cast resin and the functional wafer. Ideally, the interlayer coating will exhibit both protection and adhesion properties and, in lenses having surface features, yield uniformity of coating thickness and uniform color once activated.

### SUMMARY OF THE INVENTION

Disclosed herein are various embodiments of an optical article, such as an ophthalmic lens, with an embedded functional wafer that is coated on one or both sides with a protective coating layer.

Disclosed herein are also various embodiments of an optical article, such as an ophthalmic lens with surface features such as multifocal lenses, with an embedded functional wafer that is coated on one or both sides with a protective coating layer.

In an example embodiment, the functional wafer may comprise a polarizing medium, a decorative medium, a tinting medium, a coloring medium, an electrochromic medium, a mirrored medium, embedded electronics, patterned films, flat optics, embedded light filters, holographic optical elements, and/or a photochromic medium.

In an example embodiment, the functional wafer may be substantially flat when the coating layers are applied. In another example embodiment, the functional wafer may be curved when the coating layers are applied.

In an example embodiment, the coating layer(s) may be applied to the functional wafer using methods such as but not limited to dip coating, spin coating, spray coating, roll coating, sheet coating, printing, gravure coating, and the like.

In an example embodiment, the one or more coating layers may provide improved adhesion between the functional wafer and a surrounding lens material such as resin.

In an example embodiment, the one or more coating layers may protect the functional wafer from degradation during the lens formation process, such as due to chemical attack.

In an example embodiment, only one side of the functional wafer may be coated with a protective coating layer. In another example embodiment, both sides of the functional wafer may be coated with a protective coating layer, with a first surface of the functional wafer being coated with a first coating layer and a second surface of the functional wafer being coated with a second coating layer.

In an example embodiment, the functional wafer and coating layer(s) may comprise substantially the same curvature as the lens material in which they are embedded.

In an example embodiment, the coating may function as both a barrier layer for the functional film material and an adhesion layer between the film layer and surrounding lens resin.

In an example embodiment, the coating may have crack resistance properties allowing processing of the functional film from a flat configuration to a curved configuration for lens applications.

In an example embodiment, the coating may be under cured or partially cured on the film to increase formability during wafer thermal forming.

In an example embodiment, dual-cured thermally and light-cured coating may be utilized such that the coating is partially cured through a thermal process to provide sufficient adhesion to the film and thermos-forming capabilities.

In an example embodiment, the coating may be exposed to a light curing source such as UV, LED, or visible light with low dosage after being applied to the film.

In an example embodiment, the formable coated film may have sufficient flexibility such that coating a flat film or wafer does not result in cracking during or after thermal formation into formed wafers.

In an example embodiment, the film thickness may be between about 0.1 mm to 2 mm.

In an example embodiment, the coating may have a thickness between about 0.5 microns and 20 microns.

In an example embodiment, the film may be polycarbonate and the lens material may be formed from a liquid monomer.

In an example embodiment, the coated film may be pre-formed prior to injection molding.

In an example embodiment, the coating may be applied to the film using methods such as but not limited to spin coating, roll-to-roll coating (e.g., Gravure or slot die coating), and the like.

In an example embodiment, UV curable coating with thickness varying from about 0.8 microns to 1.4 microns may be applied using a Gravure coater.

In an example embodiment, a 150 or 180 Linear per inch micro-gravure cylinder with a helical pattern and a 45-degree engraving axis capable of transferring coating volume from about 6.0 to 14.0 cubic centimeters per square meter may be used.

In an example embodiment, excess coating may be trimmed off, such as by a metallic or plastic doctor blade.

In an example embodiment, the thickness of the coating may be uniform across an entire width of the substrate.

In an example embodiment, after application, the wet coating may be dried and/or UV-cured.

In an example embodiment, the coating may be applied on the film in the shape of a flat wafer or a formed (e.g., curved) wafer.

In an example embodiment, liquid containing solvents may be applied onto the film, with evaporation of the solvents forming a coating layer on the film.

In some aspects, the techniques described herein relate to a method of forming a cast ophthalmic lens, including: forming a coated functional wafer by coating a first surface and a second surface of a functional wafer with a coating composition; positioning the coated functional wafer within a mold; applying a resin to the first surface and the second surface of the coated functional wafer; and curing the resin and the coated functional wafer to form the cast ophthalmic lens.

In some aspects, the techniques described herein relate to a method, wherein the functional wafer is curved.

In some aspects, the techniques described herein relate to a method, wherein the functional wafer is flat.

In some aspects, the techniques described herein relate to a method, further including thermal forming the coated functional wafer so as to impart a curvature to the coated functional wafer.

In some aspects, the techniques described herein relate to a method, wherein the coating composition includes: a polymer having at least three functional groups and formed from a combination of one or more hydrolyzed siloxanes; and one or more solvents.

In some aspects, the techniques described herein relate to a method, wherein the coating composition is further included of one or more of an adhesion promoter, a UV absorbers, a colorant, or a bluing agent.

In some aspects, the techniques described herein relate to a method, wherein a solid weight of the coating composition is included of between 20-95% of the polymer.

In some aspects, the techniques described herein relate to a method, wherein the at least three functional groups include a combination of methacrylate and either hydroxyl or amine functional groups.

In some aspects, the techniques described herein relate to a method, wherein the coating composition includes: a cross-linked and solvent-resistant polymer network formed from at least three functional groups; and a flexible film forming transparent polymer.

In some aspects, the techniques described herein relate to a method, wherein the at least three functional groups are selected from the group consisting of hydroxyl, amine, imine, and methacrylate.

In some aspects, the techniques described herein relate to a method, wherein the flexible film forming transparent polymer is included of thermoplastic polyurethane and/or cellulose butyl acetate.

In some aspects, the techniques described herein relate to a method, wherein the coating composition is further included of one or more of an actinic initiator, an adhesion promoter, a UV absorber, a colorant, or a bluing agent.

In some aspects, the techniques described herein relate to a method, wherein the coating composition includes: an acrylate monomer; a polymer; and one or more solvents.

In some aspects, the techniques described herein relate to a method, wherein the resin is included of polycarbonate.

In some aspects, the techniques described herein relate to a method, wherein the functional wafer is selected from a group consisting of a photochromic wafer, an electrochromic wafer, a mirrored wafer, a polarized wafer, a holographic optical element wafer, a patterned film wafer, a light filter wafer, and a tinting wafer.

In some aspects, the techniques described herein relate to a method of forming a cast ophthalmic lens, including: forming a coated functional wafer by coating a functional wafer with a coating composition using a gravure cylinder; positioning the coated functional wafer within a mold; applying a resin to the coated functional wafer; and curing the resin and the coated functional wafer to form the cast ophthalmic lens.

In some aspects, the techniques described herein relate to a method, wherein the gravure cylinder is included of a 150 or 180 linear per inch micro-gravure cylinder.

In some aspects, the techniques described herein relate to a method, wherein the gravure cylinder includes a helical pattern.

In some aspects, the techniques described herein relate to a method, further including the step of trimming off excess coating to provide coating thickness uniformity.

In some aspects, the techniques described herein relate to a coating composition to promote adhesion and protection to a functional wafer, including: an acrylate monomer; a polymer; and one or more solvents.

In some aspects, the techniques described herein relate to a coating composition to promote adhesion and protection to a functional wafer, including: a combination of two or more compounds including silanes having formulae (I), (II) and a methacrylic acid derivative having formula (III); wherein R is a methyl group, an ethyl group, a propyltrimethoxysilyl group or a propyltriethoxysilyl group; R1 is a hydrocarbon group having 1 to 4 carbon atoms; X is a hydrolysable group including an alkoxy group, an acyloxy group, a halogen or an amine; Y is a hydrogen atom or an amino alkyl group and Z is a glycidoxy group or an epoxycyclohexyl group; one or more additives; and two or more solvents.

In some aspects, the techniques described herein relate to a coating composition, wherein the coating composition includes 20 to 95 wt % of a solid cross-linked and solvent resistant polymer network.

In some aspects, the techniques described herein relate to a coating composition, wherein the coating composition includes at least three active functional groups configured to promote covalent bonding with an optical resin of an optical article.

In some aspects, the techniques described herein relate to a coating composition, wherein the active functional groups configured to promote covalent bonding with the resin includes a hydroxyl group, an amine group, an imine group, or a methacrylate group.

In some aspects, the techniques described herein relate to a coating composition, wherein the methacrylate group is configured to promote covalent bonding with a poly(allyldicarbonate) resin.

In some aspects, the techniques described herein relate to a coating composition, wherein the hydroxyl group or the amine group are configured to promote covalent bonding with a urethane resin.

In some aspects, the techniques described herein relate to a coating composition, wherein the one or more additives include adhesion promoters, UV absorbers, colorants or blueing agents.

In some aspects, the techniques described herein relate to a coating composition, wherein the one or more additives contains 1 to 5 wt % of solid.

In some aspects, the techniques described herein relate to a coating composition of an optical wafer, including: an acrylate derivative; a transparent polymer; and one or more additives; wherein the coating composition promotes adhesion and protection to a functional wafer of an optical article.

In some aspects, the techniques described herein relate to a coating composition, wherein the composition further includes two or more solvents.

In some aspects, the techniques described herein relate to a coating composition, wherein the acrylate derivative includes 2-hydroxyethyl acrylate or ester derivatives of pentaerythritol.

In some aspects, the techniques described herein relate to a coating composition, wherein the ester derivatives of pentaerythritol further includes pentaerythritol trimethacrylate, pentaerythriol tetramethacrylate, pentaerythritol triacrylate or pentaerythriol tetraacrylate.

In some aspects, the techniques described herein relate to a coating composition, wherein the acrylate derivative contains 20 to 95 wt % of solid cross-linked polymer.

In some aspects, the techniques described herein relate to a coating composition, wherein the transparent polymer includes a thermoplastic polyurethane polymer, a thermal plastic polyester polymer, a cellulose butyl acetate (CAB) polymer or vinyl chloride-vinyl acetate copolymers.

In some aspects, the techniques described herein relate to a coating composition, wherein the transparent polymer contains 1 to 20 wt % of solid.

In some aspects, the techniques described herein relate to a coating composition, wherein the transparent polymer is configured to form flexible film.

In some aspects, the techniques described herein relate to a coating composition, wherein the transparent polymer includes a tensile stress of about 20 MPa or more.

In some aspects, the techniques described herein relate to a coating composition, wherein the one or more additives include adhesion promoters, UV absorbers, colorants or blueing agents.

In some aspects, the techniques described herein relate to a coating composition, wherein the one or more additives further includes an initiator to initiate covalent bonding of the acrylate derivative with an optical resin.

In some aspects, the techniques described herein relate to a coating composition, wherein the initiator further includes an actinic initiator, a thermal initiator, a blend of actinic initiators, a blend of photo initiators or a blend of actinic and thermal initiators.

In some aspects, the techniques described herein relate to a coating composition, wherein the coating composition is crack resistant under stretching.

In some aspects, the techniques described herein relate to a coating composition, wherein the coating composition is compatible to a condition of thermal forming of the functional wafer.

### BRIEF DESCRIPTION OF THE DRAWINGS

These and other aspects, features and advantages of which embodiments of the invention are capable of will be apparent and elucidated from the following description of embodiments of the present invention, reference being made to the accompanying drawings, in which

FIG. 1 is a cross-sectional view of a multilayered lens having a functional wafer embedded in casting resin.

FIG. 2 is a cross-sectional view of a multilayered lens having a dual-functional coating composition between the top surface of the functional wafer and the casting resin and between the bottom surface of the functional wafer and the casting resin according to one embodiment of the present invention.

FIG. 3 is a cross-sectional view of a formed functional wafer having the coating composition coated on both surfaces according to one embodiment of the present invention.

FIG. 4 is a cross-sectional view of an exemplary process for forming a coated, formed functional wafer from a coated functional sheet wafer according to one embodiment of the present invention.

FIG. 5 is a cross-sectional view of an exemplary process for forming a coated, formed functional wafer from two coated protective sheets or layers according to one embodiment of the present invention.

FIG. 6 is a table showing optical characteristics, adhesion, and environmental test results of example embodiments of coated photochromic wafers and lenses according to certain embodiments of the present invention.

FIG. 7 is a table showing certain optical characteristics, adhesion, and environmental test results of example embodiments of coated polarized wafers and lenses according to certain embodiments of the present invention.

FIG. 8 is a top view showing examples of multifocal lenses according to certain embodiments of the present invention.

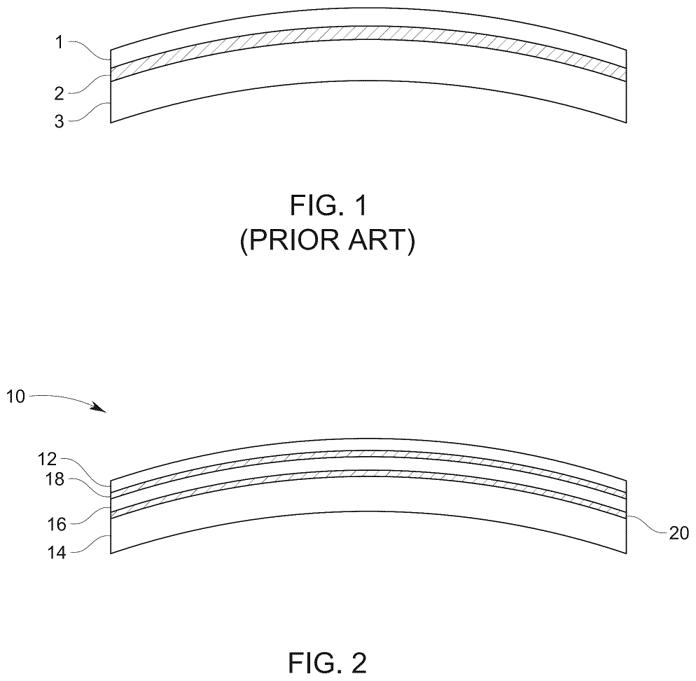

### DETAILED DESCRIPTION

Specific embodiments of the invention will now be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the embodiments illustrated in the accompanying drawings is not intended to be limiting of the invention. In the drawings, like numbers refer to like elements.

For the purposes of this specification, use of the terms “about”, “around”, or “approximately” when referring to a value may be understood to mean within 10% of the stated value (either greater or lesser), inclusive.

While different embodiments may be described in this specification, it is specifically contemplated that any of the features from different embodiments can be combined together in any combination. In other words, the features of different embodiments can be mixed and matched with each other. Hence, while every permutation of features from different embodiments may not be explicitly shown, it is the intention of this specification to cover any such combinations.

Disclosed herein are various example embodiments of an ophthalmic lens having an embedded functional wafer which may be coated on one or both sides with a coating to form a protective layer. The coating may serve dual functions of both providing adhesion between the embedded wafer and the surrounding lens material (e.g., resin) and protecting the embedded wafer from degradation or other defects due to, e.g., chemicals used during the fabrication process.

The functional wafer may provide a wide range of functions to the ophthalmic lens. By way of example, the functional wafer may comprise a polarizing medium, a decorative medium, a tinting medium, a coloring medium, a photochromic medium, a photoelectric medium, a mirrored medium, and the like. It should thus be appreciated that the systems, devices, and methods shown and/or described herein may be utilized in combination with a wide range of functional wafers or layers being applied to a wide range of types of optical articles.

The coating may comprise various compositions which may provide a wide range of benefits, including but not limited to improved adhesion and/or resistance to chemical attack. For example, the coating may provide optical quality, high transparency, and no haziness. The coating may be formulated to provide good adhesion with a variety of optical films, such as but not limited to polycarbonate, PMMA, polyester, TAC, and the like.

The coating may, for example, comprise about 20% to 95% solid weight of a cross-linked and solvent-resistant polymer network formed from at least 3 or more functional components. The polymer may be thermoset in nature. The polymer may be formed from hydrolyzed siloxane, acrylates, methacrylate, and the like. The cross-linked polymer may contain active functional groups to promote covalent bonding to a resin, such as functional groups including hydroxyl, amine, imine, and methacrylate.

In an example embodiment, the combination of both methacrylate and either hydroxyl or amine functions may be utilized; with the methacrylate group aiding in bonding of the embedded wafer and the hydroxyl/amine promoting the bonding to the urethane resins. Such an example coating may also comprise about 1% to 5% solid weight of other additives such as adhesion promoters, UV absorbers, colorants, bluing agents, and the like. Additionally, a blend of two or more solvents may be added to form a coating solution of about 3% to 20% of the above solid compositions, with the coating solution being applied to the functional film.

As another example, the coating may comprise about 20% to 95% solid weight of a cross-linked and solvent-resistant polymer network formed from at least 3 or more functional components, but in combination with about 1% to 20% solid weight of a flexible film forming transparent polymer. The polymer may be thermoplastic in nature. Tensile strength of the polymer film may be not less than 20 MPa.

Exemplary polymers may include thermoplastic polyurethane (PU), thermal plastic polyester, cellulose butyl ester such as cellulose butyl acetate (CAB), vinyl chloride-vinyl acetate copolymers, and the like. Such an example coating may also include about 1% to 10% solid weight of other additives, such as initiators (e.g., in the case of an acrylate/methacrylate polymer), adhesion promoters, UV absorbers, colorants, bluing agents, and the like.

The coating may have sufficient properties to function as a barrier layer and thereby exclude chemical attack from various optical monomers known for use in making cast lenses. The coating may provide strong bonding or adhesion between a wafer and a surrounding resin formed from a casting optical monomer. The coating may have high surface energy so as to eliminate bubbles or other defects from forming on the wafer surface during the casting process. The coating may also provide thermal formable properties.

The manner by which the coating is applied to one or both sides of a functional film or wafer may vary in different embodiments. By way of example, the coating may be applied using various methods such as but not limited to dip coating, spin coating, spray coating, roll coating, sheet coating, printing, gravure coating, and the like. The coating may be applied to the functional film or wafer prior to shaping the functional film or wafer, such as while the functional film or wafer is in a substantially flat configuration, with the resulting coated film or wafer subsequently being formed or shaped into its final shape for use in a lens. Alternatively, the coating may be applied to the functional film or wafer after the film or wafer has already been shaped (e.g., into a curved configuration).

The coating may be formulated to bond with many optical resins commonly used in the optical lens industry, including but not limited to poly(allyldicarbonate), commonly referred to as “ADC” or “CR-39”. Additional exemplary optical resins to which the coating may be bonded include urethane, ureaurethane, and thiourethane resin families and the like, which are commercially available under brand names “RAVolution”, “Trivex”, “MR-8”, “MR-10”, and “MR174”. Various other optical resins known in the art may also be utilized in conjunction with the systems and methods shown and/or described herein.

Generally, the systems and methods shown and/or described herein may be utilized to introduce one or more interlayers to a lens by embedding a coated wafer underneath the surface of the lens. Thus, the embedded wafer may generally be positioned underneath the front surface of the lens. In some embodiments, the embedded wafer may be surrounded on both sides by the lens, such that the embedded wafer is sandwiched between a front lens layer and a back lens layer. The lens layer(s) may comprise cast resin layers formed from polymer which has been polymerized from liquid monomer.

The wafer may have the substantially the same curvature as the front surface of the lens, with one or both sides of the wafer being coated with one or more compositions which form one or more protective layers separating the wafer from the surrounding lens material.

The manner by which the ophthalmic lens, including the embedded, coated wafer, may be formed may vary in different embodiments. In a first example, the coating composition may be applied on both sides of a functional wafer which has been previously shaped to conform with the curvature as a front mold using various coating methods, including those listed previously herein. In a second example, the coating composition may be applied on both sides of a functional flat sheet using various methods such as but not limited to spray coating, roll coating (i.e., wire-rod, Meyer rod coating, gravure coating, and the like). In a third example, the coating composition may be applied on one side of an optical protective layer before forming a functional laminate. The protective layer may comprise sheet or roll forms.

In embodiments in which the coating is applied to a flat or substantially flat wafer or sheet, the coated wafer or sheet may then be formed into a desired shape using various methods or processes such as a thermal forming process to stretch from a flat wafer or sheet to a curved wafer or sheet. The coating composition may thus be compatible with such thermal forming by exhibiting, e.g., crack resistance and/or adhesion resilience.

Specific example embodiments are described further below. However, it should be understood that any of the features from any of the embodiments can be mixed and matched with each other in any combination. Hence, the present invention should not be restricted to only these embodiments, but any broader combination thereof.

FIGS. 2-5 illustrate example ophthalmic lenses and methods for forming ophthalmic lenses which include an embedded, coated functional layer within the lens body. The coating may provide both protection and adhesion functionalities. The coating layers may be introduced to a functional wafer and formed into an optical article by embedding the coated functional wafer into an optical resin.

FIG. 2 illustrates an example embodiment of an ophthalmic lens 10 including an embedded functional wafer 16 that is coated on a first side with a first coating layer 18 and on a second side with a second coating layer 20. In the example embodiment shown in FIG. 2, it can be seen that the front surface of the wafer 16 may be coated with the first coating layer 18 and that the back surface of the wafer 16 may be coated with the second coating layer 20. However, it should be appreciated that, in some embodiments, only one of the surfaces of the wafer 16 may be coated (e.g., only the front surface, or only the back surface, may be coated). As shown in FIG. 2, the front and back surfaces of the coated functional wafer 16 may have the same curvatures as the front and back surfaces of the lens 10.

Continuing to reference FIG. 2, it can be seen that the functional wafer 16 may be coated with coating layer 18 on its front surface and coating layer 20 on its back surface. In some example embodiments, an ophthalmic lens 10 may be formed by embedding the front and back surface coated functional wafer 16 underneath the front resin layer 12 of the lens 10. In some examples, the ophthalmic lens 10 may be formed by embedding the front and back surface coated functional wafer 16 in between the front resin layer 12 and the back resin layer 14 of the lens 10 such as shown in FIG. 2.

In some examples, the functional wafers may comprise, for example but not limited to, a photochromic wafer, a photoelectric wafer, an electrochromic wafer, a holographic optical element wafer, a mirrored wafer, embedded electronics, a patterned film wafer, embedded light filtration, and/or a polarized wafer or combinations thereof. In some examples, additionally or alternatively, a functional wafer can have other properties, such as but not limited to, antireflective properties, mirrored properties, hydrophobic properties, hydrophilic properties, and/or antifogging properties, or any combination of the aforementioned properties.

The front resin layer 12 and the back resin layer 14 of the lens 10 may comprise cast resin layers formed from a polymer polymerized from liquid monomers. In some examples, the coating layers 18 and 20 may perform as a protective layer for the functional wafer 16 and/or an adhesion layer to the functional wafer 16. In some examples, the coating layers 18 and 20 may provide adhesion to both the functional wafer 16 and the cast resin layers 12 and 14 in the lens 10.

Various methods may be utilized for coating the functional wafer with the coating layers. In some examples, a coated functional wafer may be formed by applying a coating layer to one or both sides of a functional wafer which has the same front and back surface curvatures as the front and back lens molds. In such examples, exemplary coating methods may include, for example, dip coating, spin coating, printing, gravure coating, or spray coating.

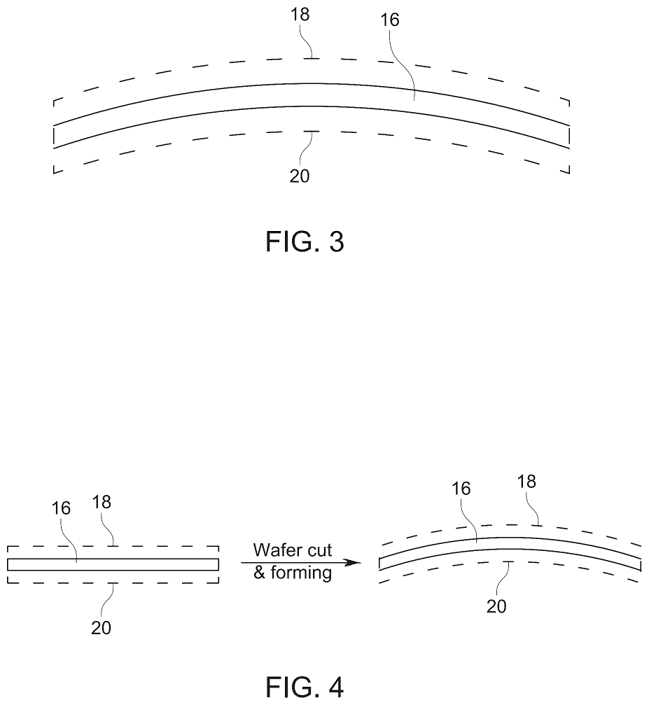

The functional wafer 16, which may be a photochromic and/or polarized functional wafer and comprise multiple layers, may have the same front and back surface curvatures as the front and back lens molds and the coating layers 18 and 20 may be applied on the front and back surfaces of the wafer 16. FIG. 3 illustrates an example embodiment of a wafer 16 coated with first and second coating layers 18, 20, with the wafer 16 and the layers 18, 20 each being curved prior to encapsulation in the resin to form the lens 10.

In other example embodiments, a coated functional wafer may be formed by applying coating compositions 18, 20 on both sides of a functional flat sheet 16. In such example embodiments, the functional flat sheet 16 may be cut and formed to generate the front and back surface curvatures of the functional wafer 16 after coating. In such process, the coated functional flat sheet 16 may undergo a forming process, such as a thermal forming process, to stretch or otherwise adjust its shape from a flat wafer to a curved wafer 16 having the same front and back surface curvatures as the front and back lens molds.

In such thermal forming processes, the coating may exhibit strong crack resistance when the coated functional flat sheet is converted from the flat configuration to the curved configuration, as well as adhesion resilience. In such examples, some non-limiting coating methods may include, for example, spray coating, dip coating, spin coating, printing, gravure coating, or roll coating (commonly known as wire-rod or Meyer rod coating).

FIG. 4 illustrates an example method of coating a functional wafer 16 in an initially flat form (e.g., a sheet) and then subsequently forming the resulting coated wafer into a desired curvature. As can be seen in FIG. 4, a functional flat sheet 16 may coated on the front and back surfaces with coating layers 18, 20. The coated functional sheet 16 may be cut and formed to generate the front and back surface curvatures of the coated functional wafer 16. The functional wafer 16 may be a photochromic and/or polarized functional wafer and may comprise multiple layers.

In some other examples, a coated functional wafer 16 may be formed by first applying a coating composition on a top surface of a first protective layer and on a bottom surface of a second protective layer. The protective layers may then be laminated with a functional layer to form a functional flat sheet, and then the functional flat sheet may be cut and formed to generate the front and back surface curvatures of the functional wafer as needed. In such processes, the coated functional flat sheet may go through a thermal forming process to stretch it from a flat wafer to a curved wafer having the same front and back surface curvatures as the front and back lens molds. In some examples, the protective layers may have sheet or roll forms.

Some non-limiting coating methods used to coat the protective layers may comprise, for example, roll coating by gravure, slot die, and flow coating. U.S. Patent Publication No. 2013/0004775, the content of which is incorporated in its entirety in this application, illustrates the formation of such a photochromic functional wafer.

In an example, a gravure coater may be utilized to apply a UV curable coating to a functional wafer 16. The thickness of the coating may vary in different examples, including but not limited to between about 0.8 microns and 1.4 microns. The gravure coater may comprise a cylinder (e.g., a gravure cylinder) having several cells which can transfer the desired amount of coating onto the substrate.

The gravure cell pattern, volume, and engraving axis may vary in different examples. In some examples, the gravure cell pattern, volume, and/or engraving axis may be matched with the appropriate coating solid % and viscosity to achieve the desired thickness and optical quality.

As an example, a 150 or 180 linear per inch micro-gravure cylinder with a helical, tri-helical, or honeycomb pattern and a 45-degree engraving axis may be used. Such a micro-gravure cylinder may be capable of transferring coating volumes from about 6.0-14.0 cubic centimeters per meter squared. Any excess coating may be trimmed off, such as by a metallic or plastic doctor blade so as to achieve uniformity of coating thickness across the entire width of the substrate. Upon successful application of the coating, the wet coating may be allowed to dry and/or undergo UV curing. Such a method of application may provide a more economical method for scaling up the coating applications discussed herein for optical and other purposes compared to, e.g., spin-coating processes.

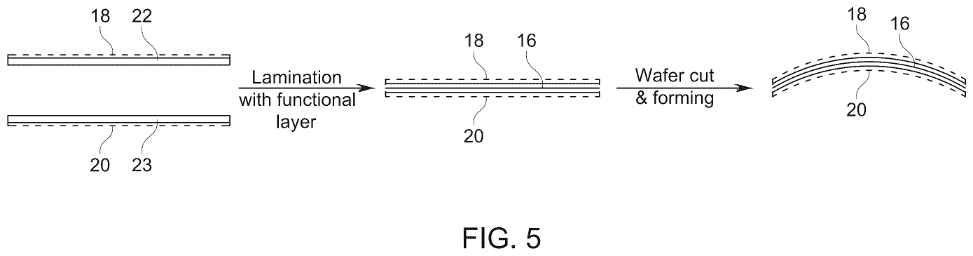

As can be seen in FIG. 5, a top surface of a first protective layer 22 and a bottom surface of a second protective layer 23 may be coated with coating layers 18 and 20. The coated protective layers 22, 23 may be laminated with a functional layer to form a functional flat sheet 16, and the functional flat sheet 16 may be cut and formed to generate the front and back surface curvatures of the functional wafer 16.

The following paragraphs describe example embodiments of coating compositions, including “coating composition A” and “coating composition B”. It should be appreciated, however, that the systems and methods shown and/or described herein may be utilized with a wide range of coating compositions, including but not limited to coating compositions A and B as described below.

Coating composition A may provide optical quality with high transparency and no haze. Coating composition A may also provide good adhesion to a variety of plastic optical films, such as but not limited to polycarbonate, PMMA, polyester, TAC. Coating composition A may also have sufficient chemical properties to function as a barrier layer to exclude chemical attack from different optical monomers used in making lenses with the casting method.

Additionally, coating composition A may provide strong bonding between the wafers and the resin formed from the casting optical monomer. Furthermore, the coating composition A may have high surface energy to eliminate the formation of bubbles on the wafer surface when casting with the optical monomer. The coating composition A may be used as a wafer coating to produce a cast optical lens with embedded functional wafer. The coating composition A may be applied on a formed functional wafer with a dip coating, spin coating or spray coating process, such as shown in FIG. 3.

Coating composition B may have all the properties of coating composition A as described in the previous paragraphs. Coating composition B, however, may additionally possess a thermal formable property. Therefore, coating composition B having the thermal formable property may be applied on the flat film surface in coating processes, for example but not limited to, a roll coating or sheet coating process and can also be applied with the dip, spin or spray coating process and may undergo thermal forming processes without showing any cracks. The coating composition B may be used as a wafer coating to produce a cast optical lens with embedded functional wafer. Example wafers that can be prepared with coating composition B are shown in FIGS. 3-5.

Thus, it should be appreciated that coating composition A may be best suited for use in coating a pre-formed, curved functional wafer 16 as shown in FIG. 3. Coating composition B may be best suited for use in coating a flat functional sheet 16 that is subsequently formed into a curvature after coating such as shown in FIGS. 4-5. It should be appreciated, however, that either coating composition A or coating composition B may be utilized with any of the processes shown in any of FIGS. 3-5.

Coating compositions A and B may comprise universal coating compositions to be applied on a wafer and bonded to many optical resins used in optical lens industry, such as poly(allyldicarbonate) normally known as ADC or CR-39 with refractive index (RI) of 1.50, the urethane, ureaurethane and thiourethane resin families with different refractive indices such as 1.50, 1.53, 1.55, 1.56, 1.60, 1.67 and 1.74. These resins are available commercially under the brand names of RAVolution, Trivex, MR-8, MR-10 and MR174.

In an example embodiment, coating composition A may comprise at least the following components 1 and 2:

Component 1 of the coating composition A may comprise: 20 to 95 solid wt % of a cross-linked and solvent-resistant polymer network formed from at least 3 and above functional components. The polymer is thermoset in nature. Two example families may include polymers formed from hydrolyzed siloxane and acrylates/methacrylate. The cross-linked polymer contains active functional groups to promote covalent bonding with the monomers added in the mold to form the optical article resin after the curing.

Example functional groups of the cross-linked polymer may include hydroxyl, amine, imine and methacrylate. The most preferred functional groups of the cross-linked polymer are the combination of both methacrylate and either hydroxyl or amine functional groups. The methacrylate functional group may facilitate covalent bonding of the embedded wafer with the ADC resin, while the hydroxyl or amine functional group of the embedded wafer may promote the covalent bonding to the urethane resins.

The siloxane coating compositions may be comprised of:
1) an aminoalkylalkoxy silane (Formulation I) such as N-(trimethoxysilylpropyl)ethylenediamine, N-(dimethoxymethylsilylpropyl)-ethylenedia-mine, aminopropyltrimethoxysilane, aminopropyltriethoxysilane, as shown in formula

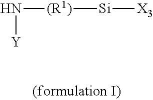

wherein, X represents a hydrolysable group, typically alkoxy, acyloxy, halogen or amine; Y is a hydrogen or an amino alkyl group and R¹ is a hydrocarbon group with 1 to 4 carbon atoms.
2) an epoxyalkylalkoxy silane (Formulation II) such as Y-glycidoxypropyltrimethoxysilane and y-glycidoxypropyltriethoxysilane, as shown in

Z—(R¹)—Si—X₃
wherein X represents a hydrolysable group, typically alkoxy, acyloxy, halogen or amine; Z is a glycidoxy group or an epoxycyclohexyl group and R¹ is a hydrocarbon group with 1 to 4 carbon atoms.

In the formulations I and II, the hydrolysable group X can be partially hydrolyzed or fully hydrolyzed in forming the coating solution.
3) a derivative of methacrylic acid (Formulation III) such as 3-(trimethoxysilyl) propylmethacrylate, as shown below:

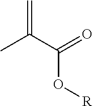

wherein R can be methyl, ethyl, propyltrimethoxysilyl or propyltriethoxysilyl function groups.

The second component 2 of the coating composition A may comprise: 1 to 5 solid wt % of other additives such as adhesion promoters, UV absorbers, colorants or bluing agents.

A blend of two or more solvents may be added to form a coating solution of 3 to 20% of the above solid from coating composition A. The coating composition A may be applied in the form of layers on the functional wafer, as shown in FIG. 2.

The coating composition B may comprise at least the following components 3, 4, and 5:
Component 3 of the coating composition B may comprise: 20 to 95 solid wt % of a cross-linked and solvent-resistant polymer network formed from at least 3 and above functional groups. The polymer may be thermoset in nature. The polymer may be formed from functional acrylates and methacrylate. The cross-linked polymer may contain active functional groups to promote covalent bonding; with the monomers added in the mold to form the optical article resin after the curing. Functional groups may include hydroxyl, amine, imine, and methacrylate. In a preferred example embodiment, a combination of both methacrylate and either hydroxyl or amine functional groups may be utilized.

The methacrylate functional group may facilitate covalent bonding of the embedded wafer with ADC resin, while the hydroxyl or amine functional group of the embedded wafer may promote the covalent bonding to the urethane resins. Non-limiting examples of acrylate monomers may include hydroxy acrylates such as 2-hydroxyethyl acrylate, esters of pentaerythritol such as pentaerythritol trimethacrylate, pentaerythriol tetramethacrylate, pentaerythritol triacrylate and pentaerythriol tetraacrylate (PETA).
Component 4 of the coating composition B may comprise: 1 to 20 solid wt % of a flexible film forming transparent polymer. The polymer may be thermoplastic in nature. Tensile strength of the polymer film may be not less than 20 MPa. Non-limiting examples of these polymers may include but not limited to thermoplastic polyurethane (PU), thermal plastic polyester, cellulose butyl ester such as cellulose butyl acetate (CAB), vinyl chloride-vinyl acetate copolymers. In a preferred example embodiment, the thermoplastic polymer may comprise CAB and PU.

CAB used in this application may have a hydroxyl level above 1.5% and melt temperature above 130° C. CAB-381-20 may have a 1.8% hydroxyl level and a melt temperature ranging from 195 to 205° C. CAB-531.1 may have a 1.7% hydroxyl level and a melt temperature ranging from 135 to 150° C.
Component 5 of the coating composition B may comprise: 1 to 10 solid wt % of other additives such as an initiator in case of acrylate/methacrylate polymer, adhesion promoters, UV absorbers, colorants, or bluing agents.

Examples of initiators which may be used with coating composition B may include an actinic initiator, a thermal initiator, a blend of actinic initiators, or a blend of actinic and thermal initiators. Actinic initiators which may be used with coating composition B may have an absorbance peak in the UV wavelength, such as benzophenone-type, alpha hydroxyketophenone such as hydroxyacetophenone, phosphineoxide, and Bis Acyl Phosphin Oxide photoinitiator. Examples of alpha hydroxyketone may include Irgacure 651, Irgacure 184, Irgancure 2959 and Darocure 1173. Examples of Bis Acyl Phosphine Oxide initiator may include bis(2,4,6-trimethylbenzoyl)-phenylphosphineoxide, which is commercially available as Omnirad 819 or Irgacure 819 and activates in the longer UVA wavelength of UV light and in the near visible region above 430 nm. Blends of a photoinitiator may be used, such as blends of Irgacure 184 and Darocure 1173, Irgacure 184 with benzophenone, and Irgacure 819 with Darocure 1173. In a preferred example, the actinic initiator may be alpha hydroxyketone and Bis Acyl Phosphine Oxide. In another preferred example, the initiator may be the alpha hydroxyketone family. In another preferred example, Darocure 1173 may be utilized.

A thermal initiator may also be used in addition to photoinitiator coating providing laden UV and thermal curing for the coating. One method is to expose the coating to UV for initial cure and then achieve additional thermal curing by exposing the coating to high temperature, such as with oven use. Thermal initiators may include peroxides that are stable at room conditions such as benzoyl peroxide, dicyclohexyl peroxydicarbonate, tert-butyl peroxybenzoate, and tert-butyl peroxide.

Example levels of a photo-initiator used in the coating composition B can be from about 1% to 10%, such as between about 3% to 5%.

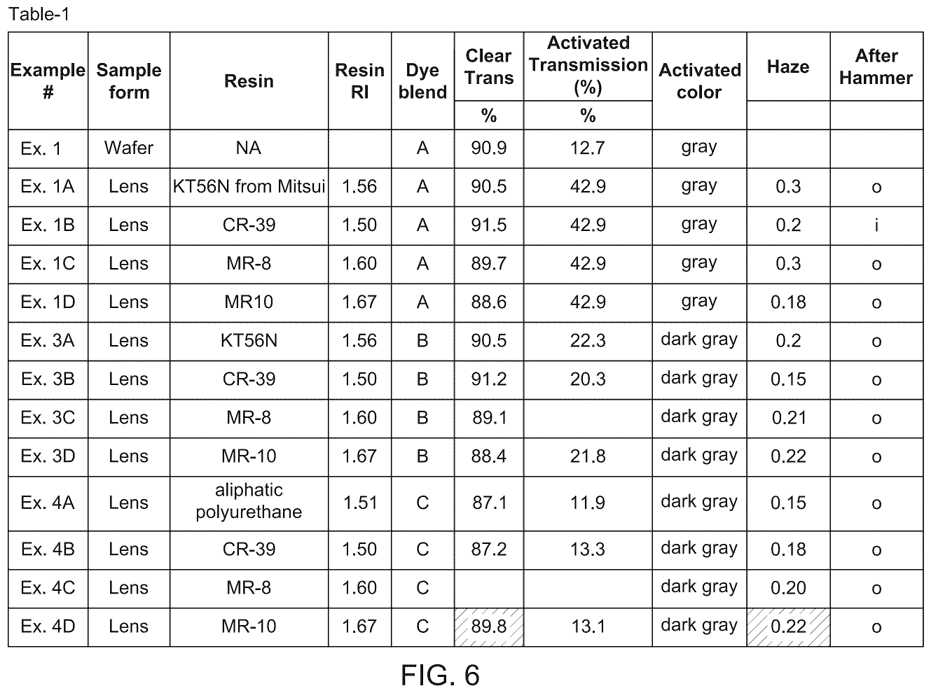

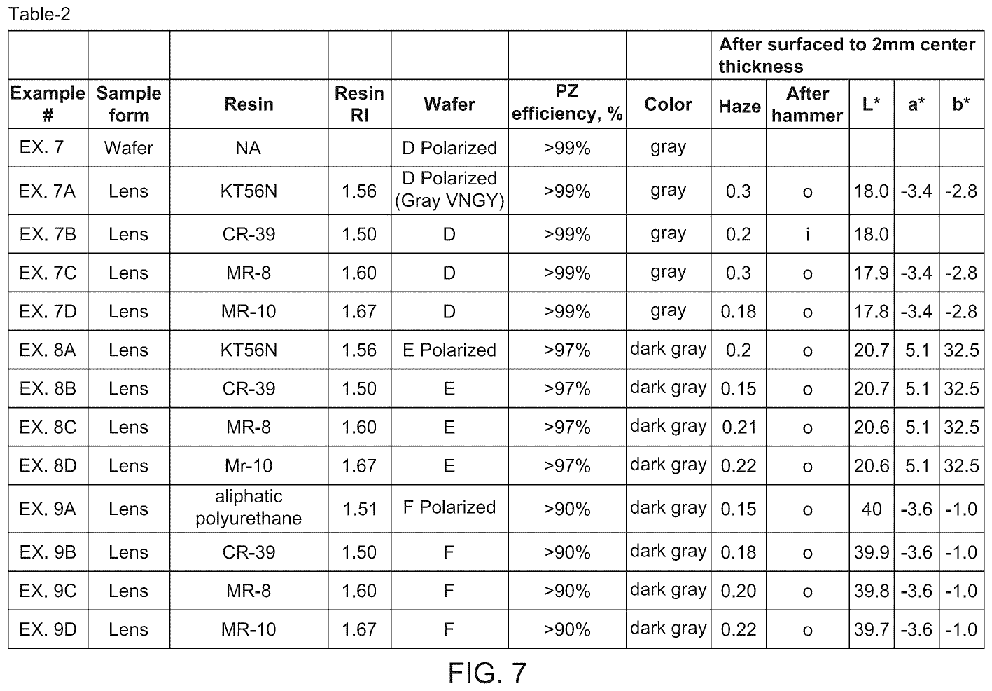

Below and shown in FIGS. 6-7 are several synthesis examples illustrating methods and characteristics of various examples:

### Example 1A

Photochromic wafer: A laminated photochromic wafer with polycarbonate film used as a protection layer was cut and formed into a 4-base wafer.

Coating solution (composition A):
Component 1: 818 g of 3-amino propyl triethoxy silane with 17 g of deionized water were combined in a reactor flask equipped with refluxing system. The solution was mixed overnight with reflux.
Component 2: 2000 g of 3-glycidoxy propyl trimethoxysilane was combined with 411 g of deionized water and 8.4 g of hydrochloric acid 10% in a reactor flask equipped with refluxing system. The solution was mixed overnight with reflux.

In a flask with thermometer and mixing equipment, 951 g of component 1 was mixed with 1261 g of component 2, the solution was heated for 30 minutes. Then 3043 g of isopropanol alcohol and 650 g of ethyl alcohol were added to form a coating solution with 23.6% of the solid.

The above coating solution was applied on a polycarbonate photochromic wafer to a dry coating thickness of 2 μm with a dip coating process. The coating is cured in oven at 115° C. for 6 hours (Example-1 in FIG. 6, table 1). The surface energy of the wafers measured by measuring contact angle with water and iodine chloride was 53 mJ/m².

Monomer solution A: A monomer solution was mixed by adding 0.17 g of dibutyl tin dichloride into of a mixture of 58.8 g 2,5 (or 2,6)-diisocyanatomethylbicyclo[2.2.1]heptane and 88.2 g of 1,6-diisocyanatohexane. Followed was 198 g of pentaerythritol tetrakis (3-mercaptopropionate). The mixture was mixed well and then degassed under vacuum of 5 mbar for 1 hour. Temperature of the solution was maintained at 10° C.

Casting article: the monomer solution prepared as above was filled into a mold which contains the above coated photochromic wafer. The monomer contacted the coating on both sides of the wafer. The whole mold/wafer/monomer was then cured in oven to allow the monomer polymerization in a ramping cycle of 21 hours long with maximum temperature of 120 degree C. in 4 hours. The cured optical article was then removed from the mold. Appearance of the casting article was clear with no bubble and no haze.

Photochromic performance of the optical article was measured, with initial transmittance being 95.9% and changing to 42.9% after 15 minutes activation.

Initial lens adhesion: A 5 kg iron hammer was dropped onto the optical article from a height of 40 cm. The optical article stayed intact in one piece. No separation between the photochromic film and the resin was observed.

Environment test: The optical article was placed in an environment chamber at 65° C. air temperature and 95% relative humidity for 288 hours. A 5 kg iron hammer was dropped onto the optical article from a height of 40 cm. The optical article stayed intact in one piece. No separation between the photochromic film and the resin was observed.

### Example 1B to Example 1D

For Examples 1B-1D, a photochromic wafer and a coating solution were prepared similarly as described above for Example 1A except in Example 1B, CR-39 was used as the cast resin; in Example 1C, MR-8 was used as the cast resin and in Example 1D, MR 10 was used as the cast resin. Appearance, photochromic activity, initial lens adhesion and environment test results of the casting articles from Examples 1A-1D are shown in Table 1.

### Example 2

Photochromic wafer: A laminated photochromic wafer with polycarbonate film used as a protection layer was cut and formed into a 4-base wafer.

### Coating Solution (Composition B):

Component 3:150 gr of CAB-531-1 was dissolved in 850 g of (ethyl 3-ethoxypropionate).

In another flask, 80 g of dipentaerythritol tetraacrylate (PETA), 10 g of the above Component 3, 450 g of glycol ether PM, 450 g of n-propanol and 10 g of alpha chloroacetyldiphenyloxide (e.g., Darocure 1173) were added to form a coating solution.

The above coating solution was applied on the above photochromic wafer to a dry coating thickness of 1.1 μm with a spin coating process with speed of 800 rpm for 1 minute. The coating was pre-dried in oven at 50° C. for 2 minutes and then UV cured with a mercury D-bulb with a dosage of 1000 mW/cm² in a Fusion UV curing system with belt speed of 10 fpm.

The coating has good adhesion to the wafer when tested with cross-hatch and tape pulling adhesion before and after boiling DI for 30 minutes. The haze reading was 0.2%. Since Example 2 describes coatings on a laminated photochromic wafer and not on a photochromic lens, hammer test was not performed for Example 2. The surface energy of the wafers measured by measuring contact angle with water and iodine chloride was 49 mJ/m².

### Example 3

The above coating solution from Example 2 was applied on a flat photochromic laminated film 8 in×11 in with a wire rod to a dry coating thickness of 0.8 μm. The coating was pre-dried in oven at 50° C. for 2 minutes and then UV cured with an Iron D-type UV bulb with a dosage of 1000 mJ/cm² in a Fusion UV curing system with belt speed of 10 fpm. The coating was repeated for the other side of the film.

The coated film was then cut and formed (as shown in FIG. 4) into 8-base photochromic wafer. The coating has good adhesion to the wafer when tested with cross-hatch and tape pulling adhesion before and after boiling DI for 30 minutes. The haze reading was 0.18%. When inspected, there was no coating cracking on both sides of the wafer.

### Example 3A to Example 3D

For Examples 3A-3D, photochromic casting articles were prepared from the photochromic wafer prepared in Example 3 but with different monomer solution in each case to form the cast resins. In Example 3A, KT56N was used as the cast resin; in Example 3B, CR-39 was used as the cast resin; in Example 3C, MR-8 was used as the cast resin and in Example 3D, MR 10 was used as the cast resin. Appearance, photochromic activity, initial lens adhesion and environment test results of the casting articles from Examples 3A-3D are shown in Table 1.

### Example 4

The coating solution in Example 2 was applied on a roll of polycarbonate film of 10 mil thick with a gravure coating process to a dry coating thickness of 0.8 μm. The coating was pre-dried in oven at 50° C. for 2 minutes before exposure to an iron D-type bulb with a dosage of 1000 mJ/cm².

The coating has good adhesion to the polycarbonate film when tested with cross-hatch and tape pulling adhesion before and after boiling DI for 30 minutes. The haze reading was below 0.18% using a haze guard.

Two rolls of coated polycarbonate film were then used to prepare a photochromic laminate sheet. The photochromic sheet was then cut and formed into 8-base photochromic wafer with 80 mm diameter. When inspected, there was no coating cracking on both sides of the wafer.

### Example 4A to Example 4D

For Examples 4A-4D, photochromic casting articles were prepared from the photochromic wafer prepared in Example 4 but with different monomer solution in each case to form the cast lenses, as shown in FIG. 6, Table-1. In Example 4A, aliphatic polyurethane was used as the cast resin; in Example 4B, CR-39 was used as the cast resin; in Example 4C, MR-8 was used as the cast resin and in Example 4D, MR 10 was used as the cast resin. Appearance, photochromic activity, initial lens adhesion and environment test results of the casting articles from Examples 4A-4D are shown in Table 1, FIG. 6.

In all the above Examples 1-4D, the photochromic dye blends A, B, C were used to prepare the functional wafers. Dye blend A contains 3% total dye, 1.5% stabilizer and the dye bend fatigue is about 3; dye blend B contains 4.1% total dye, 4.5% stabilizer and the dye bend fatigue is about 2.5; dye blend C contains 2.27% total dye, 1.5% stabilizer and the dye bend fatigue is about 2.5.

### Example 4E to Example 4H

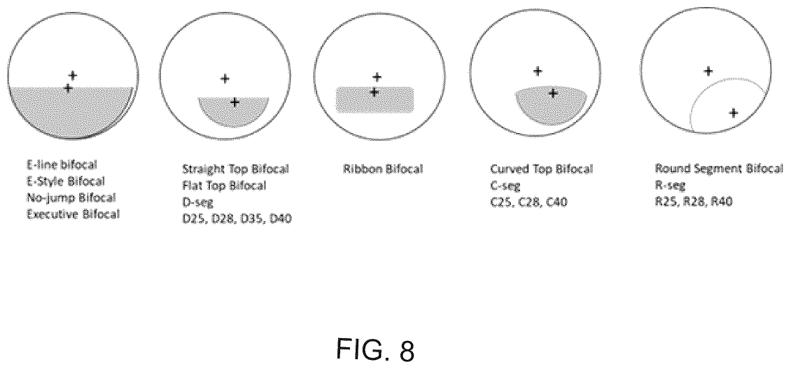

For Example 4E to Example 4H, photochromic casting articles were prepared from the photochromic wafer prepared in Example 4 but with a different monomer solution in each case to form the case lenses, such as shown in FIG. 6, Table-1. The glass molds used to prepare the casting articles were multifocal D28 glass molds. The resulting casting articles were semi-finished D28 lenses with the designs shown in FIG. 8. When the lenses were brought outside under the sun, all samples 4A to 4H activated to the same shade of gray color and faded back with similar speed when brought inside.

In all of the above Examples 1 through 4H, the photochromic dye blends A, B, C were used to prepare the functional wafers. Dye blend A may contain 3% total dye, 1.5% stabilizer, and dye blend fatigue of about 3; dye blend B may contain 4.1% total dye, 4.5% stabilizer, and dye blend fatigue of about 2.5; and dye blend C may contain about 2.27% total dye, 1.5% stabilizer, and dye blend fatigue of about 2.5.

### Comparative Example 5

A photochromic wafer, a monomer solution and a casting article was prepared in the same way as Example 1A except that the wafer was not coated with either of the coating compositions A or B. The cast article was hazy. This experiment shows that without the present of the coating compositions A or B on the photochromic wafer, the protective layers of the wafer are susceptible to chemical attack by the aggressive casting resin monomer resulting in hazy or not optically transparent product.

### Comparative Example 6 (with Coating Composition a and Added Surfactant)

### Coating Solution:

Component 1: 818 g of 3-amino propyl triethoxy silane C was combine with 17 g of deionized water in a reactor flask equipped with refluxing system. The solution was mixed overnight with reflux.
Component 2: 2000 g of 3-glycidoxy propyl trimethoxysilane was combined with 411 g of deionized water and 8.4 g of hydrochloric acid 10% in a reactor flask equipped with refluxing system. The solution was mixed overnight with reflux.

In a flask with thermometer and mixing equipment, 951 g of component 1 was mixed with 1261 g of component 2, the solution was heated for 30 minutes. Then 0.5 g of Byk 333, 3043 g of isopropanol alcohol and 650 g of ethyl alcohol were added to form a coating solution with 23.6% solid.

The above coating solution was applied on a polycarbonate photochromic wafer (a laminated photochromic wafer, with polycarbonate film used as the protection layers, was cut and formed into a 4-base wafer) to a dry coating thickness of 2 μm with a dip coating process. The coating was cured in oven at 115° C. for 6 hours. The surface energy of the wafers measured by measuring contact angle with water and iodine chloride was 38 mJ/m².

In Comparative Example 6, the coated photochromic wafer with the above the coating solution was converted to a casting article in a mold with the same monomer solution as described previously for Example 1A. The casting article was clear and with no haze but there was formation of many bubbles.

Comparative Example 6 shows that the presence of a surfactant, Byk 333, in the coating composition reduced the surface energy of the coating composition and hence bubbles were formed on the wafer surface when casting the wafer with the resin.

### Comparative Example 7-Example 9D

In Examples 7-9D, coating composition A or coating composition B coated polarized wafers and polarized lenses were prepared following the same methods as described previously for Examples 1-4D.

Example 7 and Examples 7A-7D are the same as Example 1 and Examples 1B-1D except that the wafer in Example 7 and Examples 7A-7D was a D polarized wafer with dark gray color instead of a photochromic wafer in Example 1 and Examples 1B-1D.

Examples 8A-8D are the same as Examples 3A-3D except that the wafer was a E polarized wafer with brown color in Examples 8A-8D instead of a photochromic wafer in Examples 3A-3D.

Examples 9A-9D are the same as Examples 4A-4D except that the wafer was a F polarized wafer with gray color in Examples 9A-9D instead of a photochromic wafer in Examples 4A-4D.

The appearance, photochromic activity, initial lens adhesion and environment test results of the polarized wafer and casting articles from Examples 7-9D are shown in Table 2, FIG. 7.

### Comparative Example 10

A 60% UV-curable coating solution containing mixtures of multifunctional acrylate monomers and oligomers in 35% methyl iso amyl ketone and 5% of toluene, available from PCI Labs as VG-509. The solution was diluted with a solvent mixture with a ratio of coating to solvent of 1:4. The coating solution was applied onto one side of polycarbonate roll of 12 mil thick with a gravure coating process to a dry coating thickness of 1.2 μm. The coating was pre-dried in oven at 50° C. before exposure to a metal halide lamp with a dosage of 1400 mJ/cm².

The coating showed good adhesion to the polycarbonate film when tested with cross-hatch and tape pulling adhesion before and after boiling DI for 30 minutes. The haze reading was 0.18%.

Two rolls of coated polycarbonate film were then used to prepare a photochromic laminate sheet, using the procedures and formulation described in Laminate Example L6 of U.S. Pat. No. 9,081,130, which is hereby incorporated by reference in its entirety. The photochromic sheet was then cut and formed into a single vision 4-base and a single vision 8-base photochromic wafer with 80 mm diameter. When inspected, there was no coating cracking on either side of the wafers.

Photochromic casting articles were prepared from the photochromic wafer prepared using a monomer mixture from allyl diglycol carbonate available under the commercial name TOM 1500 to form the cast lenses, as shown in FIG. 6, Table-1. The glass molds used to prepare the casting articles were multifocal D28 glass molds. The resulted casting articles were semi-finished 4-base D28 lens and a semi-finished 8-base D28 lenses with the designs shown in FIG. 8.

The 8B-base semifinished lens was then processed in a typical Rx surfacing lab to a finished +6.00 diopter photochromic D28 lens. The 4B-base semifinished lens was then processed in a typical Rx surfacing lab to a finished −4.00 diopter photochromic D28 lens. Both lenses were then applied with a scratch-resistant coating and antireflection coating in a typical Rx optical lab, resulting in coated finished lenses.

In some examples, the present application discloses the use of a dual-cured, for example, thermally cured and light-cured coating. The coating may be partially cured through a thermal process to provide sufficient adhesion to the film and thermo-forming capability.

In some examples, the present application discloses the use of a light-cured coating that is exposed to light curing sources, for example but not limited to UV, LED or visible light with low dosages after application of the coating onto the functional wafer or film.

In some examples, the thickness of the wafer may be in a range of 0.1 mm to 2 mm.

In some examples, the thickness of the coating may be in a range of 0.5 micron to 20 microns.

In some examples of the present application, the coated, flat functional sheet or wafer is preformed by undergoing a thermal forming process prior to injection molding or casting with the lens resin.

In some examples of the present application, the liquid coating composition containing solvents may be applied on a functional wafer and the solvents may evaporate to form the coating layers on the functional wafer.

### CLAUSES

Examples are set out in the following numbered clauses:
Clause 1. A method of forming a cast ophthalmic lens, comprising: forming a coated functional wafer by coating a first surface and a second surface of a functional wafer with a coating composition; positioning the coated functional wafer within a mold; applying a resin to the first surface and the second surface of the coated functional wafer; and curing the resin and the coated functional wafer to form the cast ophthalmic lens.
Clause 2. The method of clause 1, wherein the functional wafer is curved.
Clause 3. The method of clause 1, wherein the functional wafer is flat.
Clause 4. The method of clause 3, further comprising thermal forming the coated functional wafer so as to impart a curvature to the coated functional wafer.
Clause 5. The method of clause 1, wherein the coating composition comprises: a polymer having at least three functional groups and formed from a combination of one or more hydrolyzed siloxanes; and one or more solvents.
Clause 6. The method of clause 5, wherein the coating composition is further comprised of one or more of an adhesion promoter, a UV absorbers, a colorant, or a bluing agent.
Clause 7. The method of clause 5, wherein a solid weight of the coating composition is comprised of between 20-95% of the polymer.
Clause 8. The method of clause 5, wherein the at least three functional groups comprise a combination of methacrylate and either hydroxyl or amine functional groups.
Clause 9. The method of clause 1, wherein the coating composition comprises: a cross-linked and solvent-resistant polymer network formed from at least three functional groups; and a flexible film forming transparent polymer.
Clause 10. The method of clause 9, wherein the at least three functional groups are selected from the group consisting of hydroxyl, amine, imine, and methacrylate.
Clause 11. The method of clause 9, wherein the flexible film forming transparent polymer is comprised of thermoplastic polyurethane and/or cellulose butyl acetate.
Clause 12. The method of clause 9, wherein the coating composition is further comprised of one or more of an actinic initiator, an adhesion promoter, a UV absorber, a colorant, or a bluing agent.
Clause 13. The method of clause 1, wherein the coating composition comprises: an acrylate monomer; a polymer; and one or more solvents.
Clause 14. The method of clause 1, wherein the resin is comprised of polycarbonate.
Clause 15. The method of clause 1, wherein the functional wafer is selected from a group consisting of a photochromic wafer, an electrochromic wafer, a mirrored wafer, a polarized wafer, a holographic optical element wafer, a patterned film wafer, a light filter wafer, and a tinting wafer.
Clause 16. A method of forming a cast ophthalmic lens, comprising: forming a coated functional wafer by coating a functional wafer with a coating composition using a gravure cylinder; positioning the coated functional wafer within a mold; applying a resin to the coated functional wafer; and curing the resin and the coated functional wafer to form the cast ophthalmic lens.
Clause 17. The method of clause 16, wherein the gravure cylinder is comprised of a 150 or 180 linear per inch micro-gravure cylinder.
Clause 18. The method of clause 16, wherein the gravure cylinder includes a helical pattern.
Clause 19. The method of clause 16, further comprising the step of trimming off excess coating to provide coating thickness uniformity.
Clause 20. A coating composition to promote adhesion and protection to a functional wafer, comprising: a combination of two or more compounds including silanes having formulae (I), (II), and a methacrylic acid derivative having formula (III); wherein R is a methyl group, an ethyl group, a propyltrimethoxysilyl group or a propyltriethoxysilyl group; R1 is a hydrocarbon group having 1 to 4 carbon atoms; X is a hydrolysable group comprising an alkoxy group, an acyloxy group, a halogen or an amine; Y is a hydrogen atom or an amino alkyl group and Z is a glycidoxy group or an epoxycyclohexyl group; one or more additives; and two or more solvents.
Clause 21. The coating composition of clause 20, wherein the coating composition comprises 20 to 95 wt % of a solid cross-linked and solvent resistant polymer network.
Clause 22. The coating composition of clause 20, wherein the coating composition comprises at least three active functional groups configured to promote covalent bonding with an optical resin of an optical article.
Clause 23. The coating composition of clause 22, wherein the active functional groups configured to promote covalent bonding with the resin comprises a hydroxyl group, an amine group, an imine group, or a methacrylate group.
Clause 24. The coating composition of clause 23, wherein the methacrylate group is configured to promote covalent bonding with a poly(allyldicarbonate) resin.
Clause 25. The coating composition of clause 23, wherein the hydroxyl group or the amine group are configured to promote covalent bonding with a urethane resin.
Clause 26. The coating composition of clause 20, wherein the one or more additives comprise adhesion promoters, UV absorbers, colorants or blueing agents.
Clause 27. The coating composition of clause 20, wherein the one or more additives contains 1 to 5 wt % of solid.
Clause 28. A coating composition of an optical wafer, comprising: an acrylate derivative; a transparent polymer; and one or more additives; wherein the coating composition promotes adhesion and protection to a functional wafer of an optical article.
Clause 29. The coating composition of clause 28, wherein the composition further comprises two or more solvents.
Clause 30. The coating composition of clause 28, wherein the acrylate derivative comprises 2-hydroxyethyl acrylate or ester derivatives of pentaerythritol.
Clause 31. The coating composition of clause 30, wherein the ester derivatives of pentaerythritol further comprises pentaerythritol trimethacrylate, pentaerythriol tetramethacrylate, pentaerythritol triacrylate or pentaerythriol tetraacrylate.
Clause 32. The coating composition of clause 28, wherein the acrylate derivative contains 20 to 95 wt % of solid cross-linked polymer.
Clause 33. The coating composition of clause 28, wherein the transparent polymer comprises a thermoplastic polyurethane polymer, a thermal plastic polyester polymer, a cellulose butyl acetate (CAB) polymer or vinyl chloride-vinyl acetate copolymers.
Clause 34. The coating composition of clause 33, wherein the transparent polymer contains 1 to 20 wt % of solid.
Clause 35. The coating composition of clause 33, wherein the transparent polymer is configured to form flexible film.
Clause 36. The coating composition of clause 33, wherein the transparent polymer comprises a tensile stress of about 20 MPa or more.
Clause 37. The coating composition of clause 28, wherein the one or more additives comprise adhesion promoters, UV absorbers, colorants or blueing agents.
Clause 37. The coating composition of clause 28, wherein the one or more additives further comprises an initiator to initiate covalent bonding of the acrylate derivative with an optical resin.
Clause 38. The coating composition of clause 37, wherein the initiator further comprises an actinic initiator, a thermal initiator, a blend of actinic initiators, a blend of photo initiators or a blend of actinic and thermal initiators.
Clause 39. The coating composition of clause 28, wherein the coating composition is crack resistant under stretching.
Clause 40. The coating composition of clause 28, wherein the coating composition is compatible to a condition of thermal forming of the functional wafer.
Clause 41. A coating composition to promote adhesion and protection to a functional wafer, comprising: an acrylate monomer; a polymer; and one or more solvents.
Clause 42. An ophthalmic lens comprising: an outer lens layer; an inner lens layer; a functional wafer embedded between the outer lens layer and the inner lens layer; a first coating layer on a first surface of the functional wafer; and a second coating layer on a second surface of the functional wafer; and, wherein the first coating layer and the second coating layer are each operable to adhere the functional wafer to the outer lens layer and the inner lens layer.
Clause 43. A coating composition to promote adhesion and protection to a function wafer, comprising: a polymer having at least three functional groups and formed from a combination of one or more hydrolyzed siloxanes; and one or more solvents.
Clause 44. A coating composition to promote adhesion and protection to a function wafer, comprising: an acrylate monomer; a polymer; and one or more solvents.
Clause 45. A method of forming a cast ophthalmic lens, comprising: forming a functional wafer comprising protection layers on both sides; forming a coating composition and applying the coating composition on the protection layers on both sides of the functional wafer to form a coated functional wafer; placing the coated functional wafer in a mold and adding a resin monomer composition on both sides of the coated functional wafer; and curing the resin monomer composition and the coated functional wafer to form the cast ophthalmic lens.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A coating composition to promote adhesion and protection to a functional wafer, comprising:
a combination a plurality of compounds including silanes having formulae (I), (II) and a methacrylic acid derivative having formula (III); 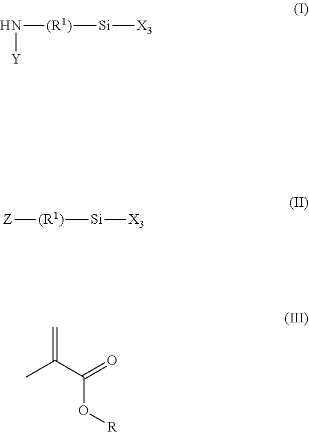
wherein R is a methyl group, an ethyl group, a propyltrimethoxysilyl group or a propyltriethoxysilyl group; R¹ is a hydrocarbon group having 1 to 4 carbon atoms; X is a hydrolysable group comprising an alkoxy group, an acyloxy group, a halogen or an amine; Y is a hydrogen atom or an amino alkyl group and Z is a glycidoxy group or an epoxycyclohexyl group;
an additive; and
a solvent.

2. The coating composition of claim 1, wherein the coating composition comprises 20 to 95 wt % of a solid cross-linked and solvent resistant polymer network.

3. The coating composition of claim 1, wherein the coating composition comprises at least three active functional groups configured to promote covalent bonding with an optical resin of an optical article.

4. The coating composition of claim 3, wherein the active functional groups configured to promote covalent bonding with the resin comprise a hydroxyl group, an amine group, an imine group, or a methacrylate group.

5. The coating composition of claim 4, wherein the methacrylate group is configured to promote covalent bonding with a poly(allyldicarbonate) resin.

6. The coating composition of claim 4, wherein the hydroxyl group or the amine group are configured to promote covalent bonding with a urethane resin.

7. The coating composition of claim 1, wherein the additive comprises an adhesion promotor.

8. The coating composition of claim 1, wherein the additive comprises 1 to 5 wt % of solid.

9. A coating composition of an optical wafer, comprising:
an acrylate derivative;
a transparent polymer; and
an additive;
wherein the coating composition promotes adhesion and protection to a functional wafer of an optical article.

10. The coating composition of claim 9, wherein the composition further comprises a plurality of solvents.

11. The coating composition of claim 9, wherein the acrylate derivative comprises 2-hydroxyethyl acrylate or ester derivatives of pentaerythritol.

12. The coating composition of claim 11, wherein the ester derivatives of pentaerythritol further comprises pentaerythritol trimethacrylate, pentaerythriol tetramethacrylate, pentaerythritol triacrylate or pentaerythriol tetraacrylate.

13. The coating composition of claim 9, wherein the acrylate derivative contains 20 to 95 wt % of solid cross-linked polymer.

14. The coating composition of claim 9, wherein the transparent polymer comprises a thermoplastic polyurethane polymer, a thermal plastic polyester polymer, a cellulose butyl acetate (CAB) polymer or vinyl chloride-vinyl acetate copolymers.

15. The coating composition of claim 14, wherein the transparent polymer contains 1 to 20 wt % of solid.

16. The coating composition of claim 14, wherein the transparent polymer is configured to form flexible film.

17. The coating composition of claim 14, wherein the transparent polymer comprises a tensile stress of at least about 20 MPa.

18. The coating composition of claim 9, wherein the additive comprises a UV absorber.

19. The coating composition of claim 9, further comprising an initiator to initiate covalent bonding of the acrylate derivative with an optical resin.

20. The coating composition of claim 19, wherein the initiator comprises an actinic initiator.
